(19) United States
(12) Patent Application Publication
(10) Pub. No.: US 2003/0117809 A1
(43) Pub. Date: Jun. 26, 2003

(54) Headlamp base

(76) Inventor: Jung-Chang Jong, Chungli City (TW)

Correspondence Address: SUPREME PATENT SERVICES, POST OFFICE BOX 2339, SARATOGA, CA, 95070, US

(21) Appl. No.: 10/027,298

(22) Filed: Dec. 21, 2001

(51) Int. Cl. B60Q 1/00

(52) U.S. Cl. 362/487

(57) ABSTRACT

A headlamp base comprises a housing body and a lighting element, wherein a rear shield is arranged behind the housing body such that some electric components connected with the lighting element, such as power cords, a starter, a stabilizer, and connection terminals, etc., are all disposed in the rear shield without needing any extra space so as to protect those electric components against dust, wet, or other foreign particles and thereby prolong the lifetime of an automobile headlamp.

### FIELD OF THE INVENTION

This invention relates generally to a headlamp, particularly to a dust-proof and waterproof headlamp base that is designed to protect inside electric components of a headlamp against dust or wet so as to prolong the headlamp's lifetime.

### BACKGROUND OF THE INVENTION

A generic automobile headlamp usually contains at least a lighting element, for example, a quartz tube or a high-pressure discharge bulb, in the housing thereof, wherein a reflector and a transparent glass shield are arranged behind or in front of the lighting element respectively. The lighting element is connected with some electric components, including power cords, connection terminals, a stabilizer, a starter, etc., which are all extended backwards to outside of the housing, and after such a lighting set is assembled, those electric components are then connected to a power supply—the automobile battery.

In abovesaid conventional headlamp structure, since the electric components are exposed to the outside air, they will corrode sooner or later because of invasion of wet, dust, or foreign particles, irrespective of protection under the automobile housing, which can be easily inferred by examining the dust rested and accumulated on the parts concealed in the automobile hood.

In view of the above-mentioned, this invention is proposed to provide an improved base structure of headlamp so as to eliminate the defects of the conventional one.

### SUMMARY OF THE INVENTION

The primary object of this invention is to provide a dust-proof and waterproof headlamp base for prolonging the lifetime of an automobile headlamp.

Another object of this invention is to provide an improved headlamp base, in which an electric component, such as a starter etc., which is particularly weak to wet is disposed in a stabilizer installed in a rear shield of the headlamp base.

In order to realize the objects, a rear shield is provided to a housing body of the headlamp base of this invention for accommodating a lighting element and some other electric components to prevent them from being corroded or spoiled.

For more detailed information regarding advantages or features of this invention, at least an example of preferred embodiment will be described below in detail with reference to the annexed drawings.

### BRIEF DESCRIPTION OF THE DRAWINGS

The related drawings in connection with the detailed description of this invention to be made later are described briefly as follows, in which:

FIG. 1 shows a headlamp base of this invention in three dimensions;

FIG. 2 is an exploded view showing the main components of the headlamp base of this invention in three dimensions;

FIG. 3 is a cutaway sectional view of the headlamp base of this invention;

FIG. 4 is a cutaway sectional view showing an embodiment of a flashlight style headlamp base of this invention; and

FIG. 5 shows an embodiment of this invention made in form of a circular headlamp base.

### DETAILED DESCRIPTION OF THE INVENTION

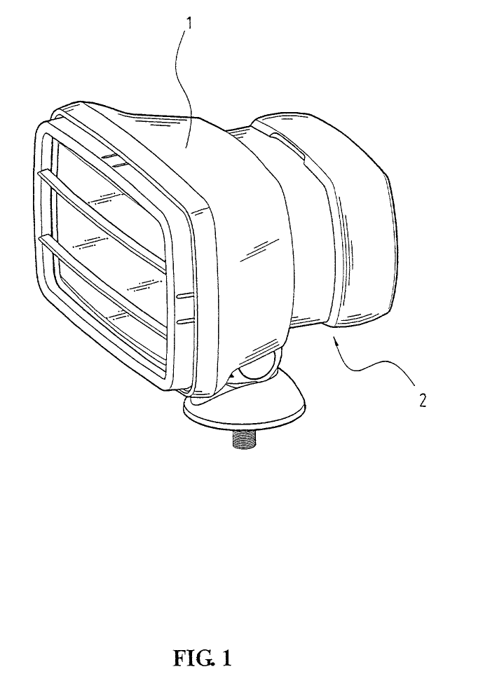

Referring to FIG. 1, a headlamp base of this invention suitable for automobile headlamp and emergency lighting comprises a housing body 1 and a rear shield 2 disposed behind the housing body 1.

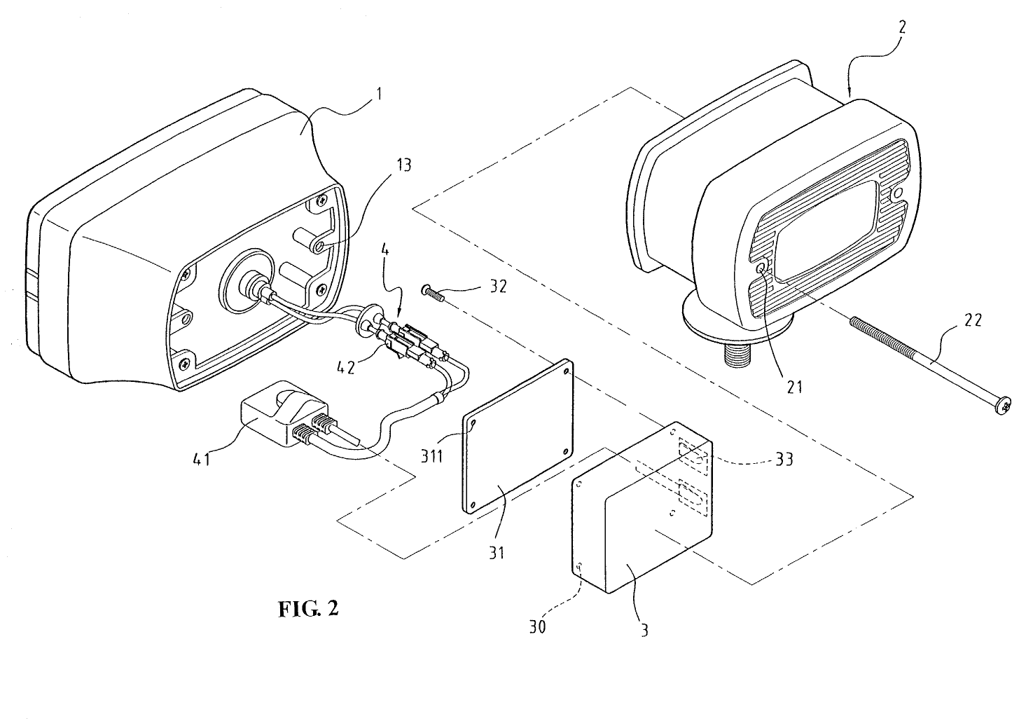

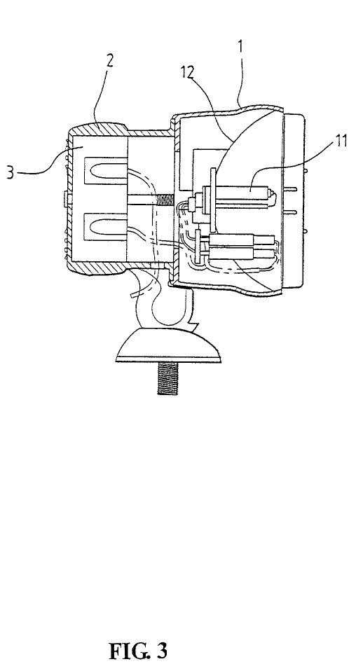

As illustrated in FIGS. 2 and 3, a reflector 12 and a lighting element 11, such as a quartz tube or a high-pressure discharge bulb, are disposed in the housing body 1, in which a power cord connected with the lighting element 11 is extended backwards behind the housing body 1. The power cord is jointed with connection terminals 42, a starter 41 and a stabilizer 3, etc., to form an electric unit 4 for starting the lighting element 11. A plurality of tapped holes 13 is distributed on the back of the housing body 1, and a plurality of set holes 21 is arranged on the back of the independently formed rear shield 2 in positions such that bolts 22 can penetrate the set holes 21 and to be locked in the tapped holes 13 to have the rear shield 2 itself fixed on the housing body 1.

The stabilizer 3 is fitted in the rear shield 2 and provided with an opening having a plurality of peripheral tapped holes 30. The opening is covered with a lid 31 having a plurality of through holes 311 at positions corresponding to that of the tapped holes 30 so that the lid 31 can be fixed at the stabilizer 3 by penetrating several screws 32 through the through holes 311 for being locked in the tapped holes 30 of the stabilizer 3. Moreover, a gap 33 is formed in a lateral wall of the stabilizer 3 for the power cord to pass through.

With regard to building the headlamp structure stated above, the electric unit 4 behind the housing body 1 might be fitted in the rear shield 2, and the electric components, which are relatively weak to wet, are placed in the space of the stabilizer 3. Now the power cord leads to penetrate through the gap 33 and the opening of the stabilizer 3 is covered with the lid 31. The next steps shall include: penetrating the screws 32 through the through holes 311 of the lid 31 and locking them in the tapped holes 30 of the stabilizer 3 to seal its opening; placing the stabilizer 3 in the rear shield 2 and penetrating the bolts 22 through the set holes 21 of the rear shield 2, then locking them in the tapped holes 13 on the back of the housing body 1 so as to fix the rear shield 2 behind the housing body 1 to thereby complete the structure of a headlamp base capable of preventing the electric unit 4 from being spoiled by dust, wet, or some foreign particles.

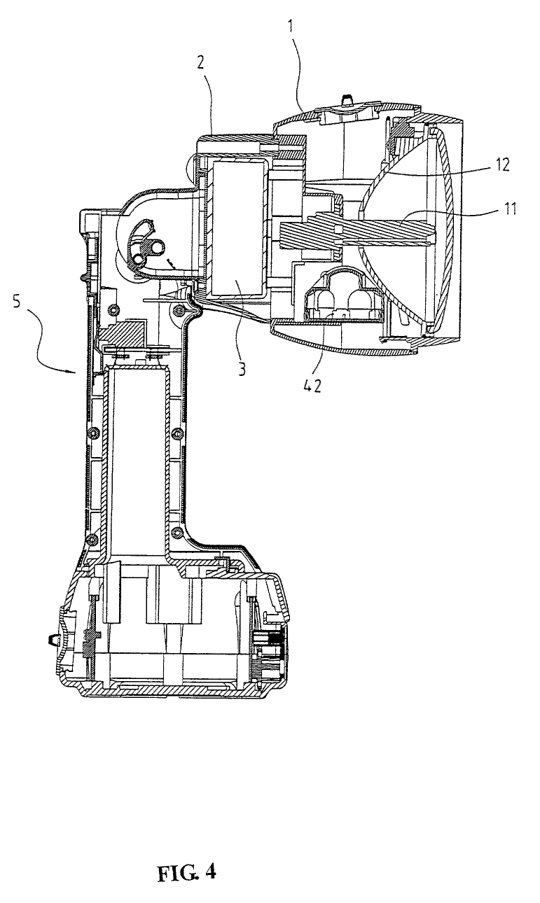

Moreover, the structure of the headlamp base of this invention is also applicable to a headlamp of flashlight style shown in FIG. 4, in which, in addition to a grip 5, the lighting element 11 and the reflector 12 are disposed in the housing body 1 as usual, and the rear shield 2, which accommodates the stabilizer 3, connection terminals, and the starter, etc., is mounted on the rear end of the housing body 1.

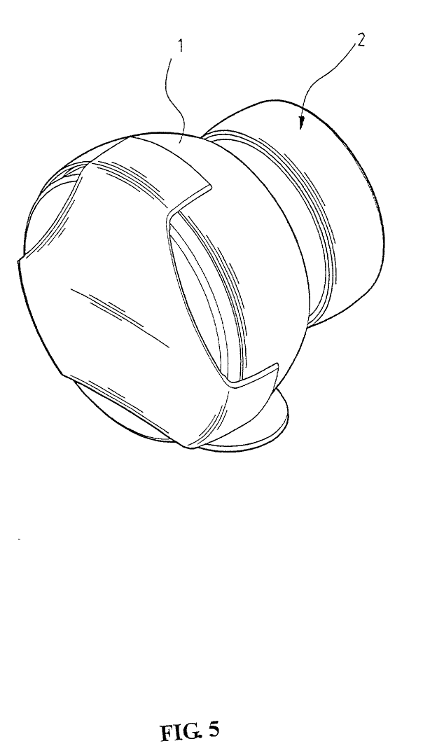

The configuration of the headlamp shown in FIG. 1 is square though, the housing body 1 and the rear shield 2 of this invention might be designed in circle as an alternative, as shown in FIG. 5.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A headlamp base, comprising a housing body having a reflector and a lighting element, and a plurality of electric components connected with the lighting element being penetrating through a rear end of the housing body, in which a rear shield provided with a stabilizer having an inside space is arranged behind the housing body so that the plurality of electric components is accommodated in the rear shield or a part of them is received in the stabilizer.

2. The headlamp base according to claim 1, in which a plurality of tapped holes and set holes are distributed on the back of the housing body and the rear shield respectively such that a plurality of bolts is allowed to penetrate the set holes of the rear shield for being locked in the tapped holes of the housing body to thereby fix the rear shield onto the housing body.

3. The headlamp base according to claim 1, in which an opening sealed with a lid and a gap in a lateral wall are provided to the stabilizer.
